(19) United States
(12) Patent Application Publication
(10) Pub. No.: US 2005/0097875 A1
(43) Pub. Date: May 12, 2005

(54) Travelling soil cultivation appliance, especially a lawnmower

(76) Inventors: Reiner Haeufele, Laupheim (DE); Wolfgang Lindermeir, Untermarchtal (DE); Ulrich Schaub, Ulm (DE)

Correspondence Address: AKERMAN SENTERFITT, P.O. BOX 3188, WEST PALM BEACH, FL, 33402-3188, US

(21) Appl. No.: 10/467,030

(22) PCT Filed: Feb. 1, 2002
(86) PCT No.: PCT/EP02/01059

(30) Foreign Application Priority Data
Feb. 3, 2001 (DE) 101 05 005.4

(51) Int. Cl. A01D 34/03

(52) U.S. Cl. 56/17.5

(57) ABSTRACT

The invention relates to a soil cultivation appliance, especially a lawnmower (1), which can be motor-driven or manually driven. Said appliance is provided with a steering shaft (8) and a steering frame (7) or wheel for the operator. Said steering device enables the soil cultivation appliance to change direction due to the fact that torque is introduced into the housing (2) of the soil cultivation appliance by means of the steering shaft (8), said torque being then used to change the direction of the advancing movement, to the left or to the right, without needing to steer the wheels. An advantage of the novel embodiment is that, when the steering shaft (8) is arranged on the housing (2) in a continuously pivotable manner, the position of the operator is independent from a thrust frame or the like, by which means the soil cultivation appliance must be mechanically guided.

The invention relates to a travelling soil cultivation appliance, particularly a lawnmower having a housing for receiving the cultivating elements and with a guide device, which can be handled by an operator and which is pivotably arranged on the housing with respect to an axis substantially vertical to the cultivating plane.

Travelling lawnmowers normally have as the guide mechanism a thrust frame, which is firmly positioned on the housing by means of two legs. The housing generally has four wheels, which are in each case arranged pairwise on a front and a rear wheel axle. The front wheels can also be replaced by a single, central front wheel. Such lawnmowers are advanced either by a motor drive of the rear wheels or by the operator by means of the thrust frame, said thrust frame fixed to the lawnmower casing also being used for steering the mower by lateral pressure and/or by raising non-pivotable front wheels from the ground. Such lawnmowers or other soil cultivation appliances suffer from the disadvantage that steering and guidance of the appliance is only possible when the operator is in front of or, if the thrust frame is positioned in pivotable manner, behind the lawnmower. If it is necessary to deal with obstacles such as e.g. overhanging bushes, guidance becomes difficult or impossible.

Therefore a lawnmower with a pivotable guide frame is known (DE-OS 2 448 129), in which the guide frame is so articulated to a ring rotatable with respect to the mower housing that it is pivotable about the rotation axis of the ring in 90ø stages and about its horizontal articulation axis up to an angle of 180ø. This design permits an orientation of the thrust frame in a direction perpendicular to the direction of travel. However, the desirable guidance from intermediate positions is impossible.

Therefore the problem of the present invention is to so design a soil cultivation appliance, particularly a lawnmower of the aforementioned type that guidance and steering are possible from all positions.

In the case of a soil cultivation appliance of the aforementioned type, this problem is solved in that the guide mechanism is provided with a rotary steering device, whose rotary movement at or in the housing can be converted into a torque about a vertical axis. Therefore the possibility of steering the soil cultivation appliance which has hitherto only been possible by means of a thrust frame acting externally on the housing has now been modified in such a way that the torque exerted by the operator on a steering device is transmitted as a torque exerted on the housing of the soil cultivation appliance or lawnmower. The guide mechanism can therefore be designed so as to be freely movable about the axis vertical to the cultivation plane, because unlike in the case of known constructions, it does not directly serve as a lever for exerting steering forces.

According to a further development of the invention, the steering device can comprise a steering shaft with a steering wheel facing an operator or a steering frame. The steering shaft is advantageously constructed as a telescopic shaft, which also makes it possible to guide the cultivation appliance from to a certain extent differing distances.

According to a further development of the invention, the steering shaft can be oriented under a predetermined angle to the cultivation plane and on the housing can be fitted to a bearing body, which is pivotably mounted about the vertical axis in the housing. Unlike in the case of the aforementioned, known construction, in which the pivotable ring on which the thrust frame is located must be firmly lockable in positions displaced by in each case 90ø in order to permit guidance by means of the thrust frame, the bearing body can be positioned in a freely movable manner, because it does not serve as an element with which a torque must be transmitted. Thus, the steering shaft can be guided from different positions with respect to the housing of the lawnmower or the like, which significantly improves the cultivation possibilities.

In a development of the invention, the steering shaft can traverse the bearing body and act with at least one offset on a support surface of the housing, which is located at least in a direction parallel to the cultivation plane spaced from the bearing body. This makes it possible to exert lateral or component forces on the housing of the soil cultivation appliance which, since their application points in the longitudinal direction of the housing differ, exert a torque on the housing for guidance purposes.

According to a further development of the invention, the support surface can be part of a guide casing for the bearing body firmly held in the housing and which forms a shaft with side walls oriented parallel to the direction of travel of the soil cultivation appliance and which serve as support surfaces. Such a design allows a pivoting of the steering shaft about the vertical axis and whilst the offset thereof admittedly comes to rest at different locations, it always engages on the shaft side walls and consequently makes it possible to exert the necessary steering forces.

In an embodiment advantageous because of its great simplicity, the offset of the steering shaft can be constructed as a laterally projecting arm provided at its free end with a slider guided on both side walls of the shaft. This design ensures that in all pivot positions of the steering shaft the slider exerts lateral forces in one or other direction on the housing, which lead to the desired steering torque with the opposing forces exerted by the counterbearing of the steering shaft in the bearing body.

The hitherto described design according to the invention provides a steering shaft, which is oriented under a predetermined, fixed angle with respect to the cultivation plane. However, it is also possible to fit the steering shaft part traversing the bearing body on the bearing body side directed towards the operator in articulated manner on the further part of the steering shaft and this can e.g. take place by means of a universal joint. With such an embodiment the steering shaft is freely movable about the vertical pivot axis of the bearing body, but is also pivotable, at least to a certain extent, relative to the soil cultivation plane, so that the guidance and cultivation possibilities are further extended. The steering shaft held by the operator can consequently be held higher or lower with respect to the ground.

According to another embodiment, which allows a certain height change when handling the steering shaft, the steering shaft is provided at the end facing the housing with a bevel gear, which cooperates with a corresponding toothed disk fixed to the housing. Also in the case of such an embodiment, where naturally there is also a pivotability about the vertical axis, the steering shaft can be raised or lowered to a certain extent without the guidance function being lost.

In a further development of the invention, the steering shaft can be constructed as a flexible shaft, which can e.g. be guided in a support body pivotable about a vertical axis. A design where the soil cultivation appliance is appropriately motor-driven is possible according to the invention because the torque for steering the soil cultivation appliance is not exerted by means of a lever action of a thrust frame or the like. Tests have shown that with the novel design according to the invention there is a completely satisfactory guidance-steering possibility for the soil cultivation appliance or lawnmower. It has been found to be particularly appropriate if the housing is provided with front and rear wheels, the vertical axis about which the torque is exerted is positioned between the front and rear wheels and the spacing of the vertical axis in the housing longitudinal direction is less than 30% of the spacing between the front and rear wheel axes.

It is also possible to provide one or two casters on the front wheel arrangement. However, it has been found that excellent steering possibilities also exist if the wheel arrangements are not steerable and the contact surfaces of the wheels have a limited sliding resistance with respect to lateral displacement.

Embodiments with a rigid or also a length-blockable telescopic shaft as the steering shaft also permit the advance of the soil cultivation appliance or lawnmower through manual pushing by an operator.

The guidance mechanism can finally be fitted in removable manner to the housing in order to render more compact for transportation or storage purposes the soil cultivation appliance or lawnmower.

The invention is described in greater detail hereinafter relative to embodiments and the attached drawings, wherein show:

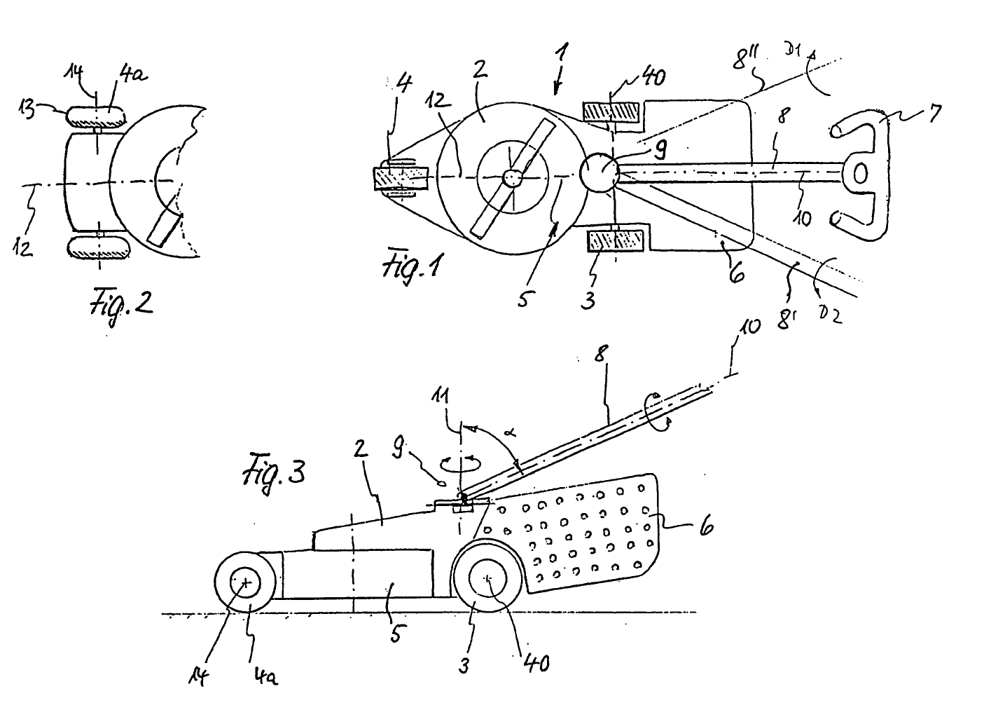

FIG. 1A plan view of a lawnmower according to the invention having a housing with four wheels.

FIG. 2A variant of the embodiment of FIG. 1 with a different front wheel design.

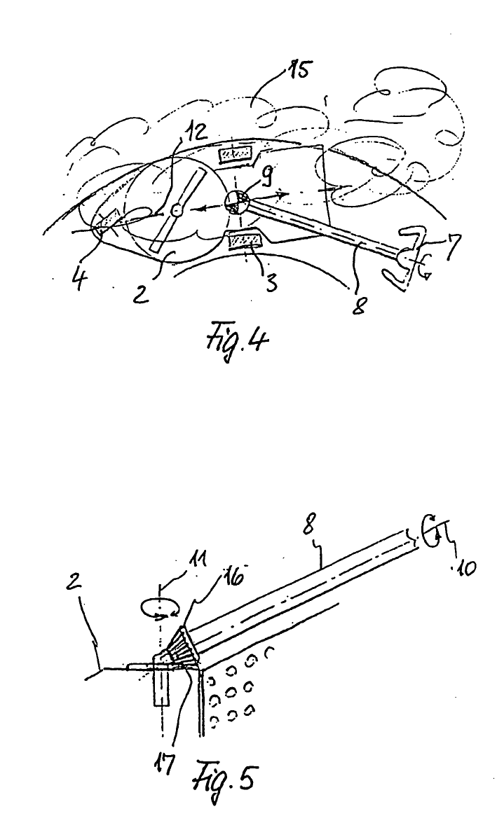

FIG. 3A side view of the lawnmower of FIG. 1.

FIG. 4A diagrammatic representation of the lawnmower according to FIGS. 1 and 3 in a plan view during cornering.

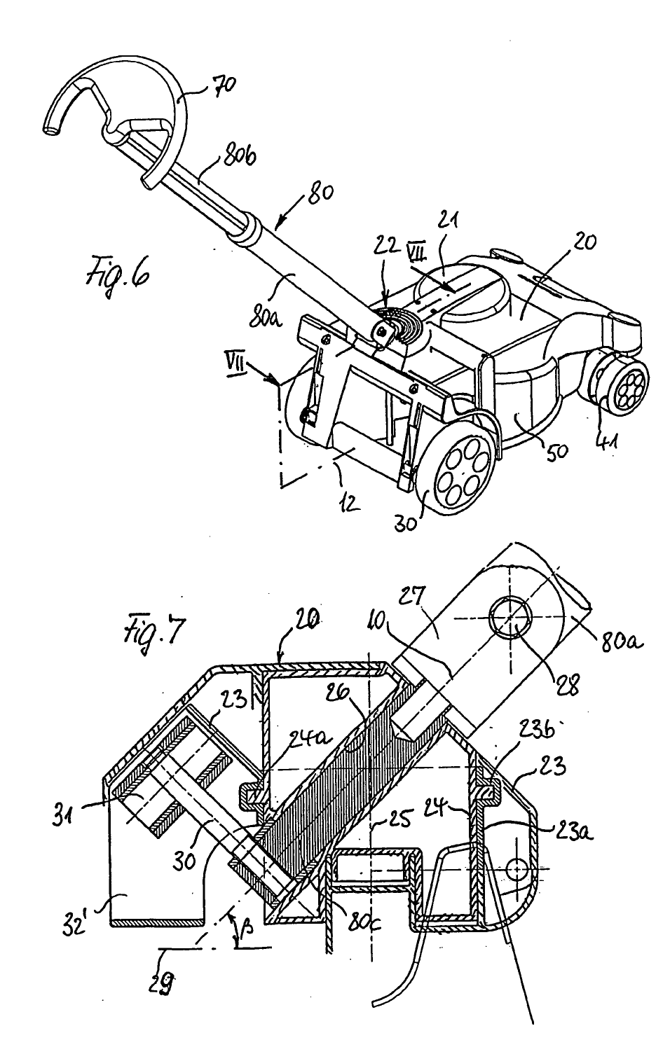

FIG. 5A diagrammatic partial view of a steering device according to the invention in a modified embodiment compared with FIGS. 1 to 4.

FIG. 6A perspective view of another embodiment of a lawnmower.

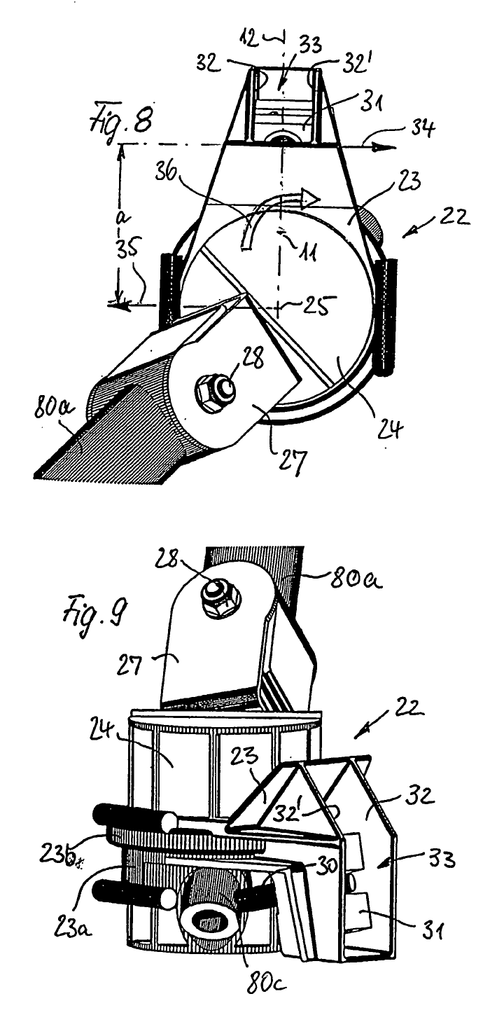

FIG. 7A larger-scale partial representation of a section along plane VII in FIG. 6 in the steering shaft application area.

FIG. 8A plan view of the guide casing shown in part sectional form in FIG. 7.

FIG. 9A perspective side view of the guide casing according to FIGS. 7 and 8.

The lawnmower 1 shown in FIGS. 1 and 3 has a housing 2, which is able to travel on two rear wheels 3 with aligned wheel axes or axles and a front wheel 4, which can e.g. be constructed as a caster freely pivotable about a vertical axis. Between the rear wheel axis 40 and the front wheel 4 the motor and blade 5 are located inside the mower housing 2. A cut material collector 6 is provided at the rear end of the mower, facing the user.

The user moves the lawnmower by means of a guidance mechanism, which in the embodiment shown comprises a user-side gripping frame 7 and a steering shaft 8 leading from the latter to the mower housing 2. The steering shaft 8 is articulated to the mower housing 2 in a steering mechanism 9 and rotatable about its longitudinal axis 10. The gripping frame is connected to rotate with the steering shaft. The steering mechanism 9 is designed in such a way that a rotation of the steering shaft 8 about its longitudinal axis 10 is coupled with a pivoting of the orientation of the steering gear about a substantially vertical pivot axis 11 in the steering mechanism 9 relative to the mower housing. As a result of said coupling, a torque exerted by an operator by means of the gripping frame 7 about the longitudinal axis 10 of the steering shaft 8 in the steering mechanism 9 is converted into a torque about the vertical pivot axis 11 acting on the mower housing 2.

With such an arrangement, the operator can pivot the steering shaft 8 about the vertical pivot axis 11 and can take up a position laterally displaced against the mower longitudinal axis 12 and without changing his own position by exerting a torque by means of the gripping frame 7 on the steering shaft 8 can pivot the mower housing 2 relative to said steering shaft about the vertical pivot axis 11. In plan view, the pivot axis 11 is advantageously slightly spaced from the rear axis or axle 40. The horizontal spacing of the pivot axis 11 from the common rear axis 40 of the rear wheels 3 is preferably less than 30%, particularly less than 20% of the horizontal spacing of the front wheel 4 from the rear axis 40. On exerting a torque in this way, the mower housing 2 is pivoted about the pivot axis 11 relative to the operator until the desired orientation is obtained.

The resistance to the orientation change is particularly low when using a pivotable caster 4 as the front wheel and this also applies in the same way for a pair of casters as laterally spaced front wheels. It has surprisingly been found that front wheels 4a running on rigid axles 14, as shown in the front part of a mower in FIG. 2, also allow such a mower housing pivoting, particularly if such rigidly oriented wheels 4a are slightly profiled or completely smooth and have clearly arcuate or arched contact surfaces 13. It is obviously possible to have a single front wheel with a rigid wheel axle.

FIG. 1 shows the starting positions of the steering shaft 8 with continuous lines and two laterally pivoted orientations 8′, 8″ of the steering shaft corresponding to opposing rotations D1, D2 of the steering shaft about its steering axis by means of broken lines.

FIG. 4 illustrates a situation where the mower housing is guided on a curved path with the operator position laterally displaced with respect to the longitudinal axis 12 and which as a result can e.g. be easily used under a bush 15 or some other difficultly accessible location.

According to the variant of FIG. 5, the steering mechanism 9 contains a bevel gear transmission with a bevel gear 16 rotatable with the steering shaft about its longitudinal axis and a gear rim or partial gear rim 17 on the side of the mower housing 2. Another variant of the steering mechanism can have a universal joint, particularly an offset universal joint, a ball end joint or some other joint transmitting torque with angular displacement. In the case of the variant with a bevel gear transmission 16, 17, the inclination angle of the longitudinal axis 10 of the steering shaft 8 shown in side view in FIG. 3 is typically fixed with respect to the vertical pivot axis 11 or can only be modified to a limited extent, whereas in the case of the variant of a steering mechanism with a universal joint said angle can be modified over a larger, but still limited range.

It is common to the embodiment shown that the torque axis 10 of the torque exerted by the user on the gripping frame does not coincide with the torque axis 11 of the torque acting on the mower housing. The mower can be self-propelled or also pushed.

The length of the thrust frame arrangement is preferably variably adjustable, which in particular, as will be explained relative to FIG. 6, can in advantageous manner be implemented by constructing the steering shaft 8 as a telescopic tube.

FIG. 6 shows a lawnmower having a travelling housing 20 with in each case front wheels 41 and rear wheels 40 and which in similar manner to the embodiment of FIGS. 1 and 3 is equipped with a motor and a blade casing part 50. On its top surface the housing 20 is provided, in addition to a lid 21 giving accessibility to the drive motor, with the cover 22 visible in FIG. 6 for a guide casing 23 used for receiving the steering shaft 80 and which her comprises two telescopically guided parts 80a and 80b. On part 80b is located a steering wheel 70 by means of which an operator, in much the same way as in the embodiment of FIGS. 1 and 3, can exert a steering torque on the lawnmower housing 20.

The guide casing 23 is located in fixed manner in the interior of the housing 20 and which comprises, a shown in FIGS. 7 to 9 a casing part firmly inserted in the housing 20 and in which is held a roughly cylindrical bearing body so as to rotate about axis 25 as a result of the fact that it is inserted in a corresponding cylindrical guide 23a of the guide casing 23 and is held with a flange 24a in a corresponding annular groove 23b of the guide casing. In the embodiment, the bearing body 24 is provided with a cylindrical guide 26 inclined by an angle to a plane 29 and in which is inserted the cylindrical end of the steering shaft 80. In the embodiment, the steering shaft part 80a is not constituted by a continuous, one-piece shaft part, but instead by the end piece 80c, which runs coaxially to the steering axis 10 in guide 26 and a link plate 27 connected to rotate with said shaft end 80c and in which with the aid of a tie bolt 28 the shaft part 80a is inserted in removable manner, but aligned with the shaft axis 10. The shaft part 80a with the shaft part 80b displaceably held therein and the steering wheel 70 is therefore arranged in removable manner, so that the lawnmower is not too bulky and does not take up too much space for transportation or storage purposes.

In the free end portion of the shaft end 80c is inserted an arm 30 in the form of a bolt projecting perpendicularly to axis 10 and which is in turn provided at its free end with a slider 31 held in rotary manner thereon. Said slider 31 engages on the lateral surfaces 32 and 32′ of a shaft 33, which is fitted in one piece on the guide casing 23 and extends with its parallel side walls 32, 32′ over a height sufficiently great to ensure the engagement of the slider 31 in all pivoting positions of the steering column 80 within the shaft 33 and the corresponding displacement movement of the slider within the shaft 33.

As can be gathered from FIGS. 6 to 9, the exerting of a torque on the steering wheel 70 consequently brings about a torque in the shaft 80. The end piece 80c of the steering shaft 80 then attempts to pivot the arm 30 in one or other direction. However, the slider 31 of arm 30 is guided in firmly engaging manner on the lateral surfaces 32, 32′ of shaft 33, so that e.g. on exerting a clockwise torque (FIG. 8), the slider 31 is pressed against side wall 32′ and consequently exerts a lateral force in the direction of the arrow 34 on the guide casing 23 and, as the latter is firmly located in the housing 20, also on the latter. The opposing force resulting from the exerting of said force in the direction of the arrow 34 by means of the steering shaft part 80c is supported in the bearing body 24, which in turn presses in the opposite direction to the force according to arrow 34 against its guide casing 23 and consequently exerts a force in the direction of arrow 35 on the guide casing and on housing 20. Both forces acting in the direction of arrows 34 and 35 consequently bring about a torque on the housing 20 in the direction of the arrow 36, which acts about the vertical axis 11 and in the same way as has been described relative to the embodiment of FIGS. 1 to 3 can be utilized for guiding the lawnmower.

It is immediately clear that it is not a matter of an orientation of the steering shaft 80 inclined by an angle with respect to the cultivation surface in the direction of travel, i.e. in the direction of the longitudinal axis 12 or the sectional plane VII in FIG. 6. As is also shown in FIG. 1, the steering shaft 80 can be inclined to said longitudinal axis 12 and can also be pivoted with respect thereto during the cultivation process. This merely brings about a displacement of the slider 31 within the shaft 33, but does not prejudice the action of the steering process.

Here again it is appropriate for the contact surfaces of the wheels 41 and optionally also the wheels 30 to have a minimum sliding resistance. However, it has been found that this is not absolutely necessary and that a torque applied by means of the steering wheel 70 can be sufficient to bring about the desired cornering of the lawnmower.

It would also be possible to use in place of the steering shaft 80, which has a rigid construction transversely to its longitudinal axis 10, to use a flexible shaft by means of which the desired torque can be introduced into the housing 20. It is also possible not to provide the steering shaft 80 with the projecting arm 30 as an offset and instead to equip it within the housing 20 with at least one offset, which in the same way as in the embodiment shown exerts a lateral force in one direction on the housing 20 and in the longitudinal direction of said housing 20, i.e. in the direction of the longitudinal axis 12, and in displaced manner with respect thereto brings about an opposing force in the opposite direction, which once again is used for producing the desired torque on housing 20.

The novel manner of steering a soil cultivation appliance consequently allows the continuous position change of an operator with respect to the appliance, without thereby impairing the steerability of said appliance.

1. Travelling soil cultivation appliance, particularly a lawnmower, having a housing (2,20) for receiving cultivation elements (5, 50) and with a guide mechanism which can be handled by an operator and which is pivotably located on the housing (2, 20) with respect to an axis (11, 25) substantially vertical to the cultivation plane (25), characterized in that the guide mechanism is provided with a rotatable steering device (7, 8; 70, 80), whose rotary movement at or in the housing (2, 20) can be converted into a torque (36) about a vertical axis (11, 25).

2. Soil cultivation appliance according to claim 1, characterized in that the steering device comprises a steering shaft (8, 80) with an operator-facing steering wheel (7, 70) or steering frame.

3. Soil cultivation appliance according to claim 2, characterized in that the steering shaft (8, 80) is constructed as a telescopic shaft.

4. Soil cultivation appliance according to claim 2, characterized in that the steering shaft (80) is oriented under a predetermined angle (β) to the cultivation plane or to a plane (25) parallel thereto and on the housing (20) is fitted to a bearing body (24), which is mounted in the housing (20) so as to pivot about the vertical axis (25).

5. Soil cultivation appliance according to claim 4, characterized in that the steering shaft (80) traverses the bearing body (24) and acts with at least one offset (30) on a support surface (32) of the housing (20), which is located at least in a direction parallel to the cultivation plane at a distance (a) from the bearing body (24).

6. Soil cultivation appliance according to claim 5, characterized in that the support surface (32) is part of a guide casing (23) for the bearing body (24) held in fixed manner in the housing (20) and which forms a shaft (33) with side walls (32, 32′) oriented parallel to the direction of travel (12) of the soil cultivation appliance and which serve as support surfaces.

7. Soil cultivation appliance according to claim 6, characterized in that the offset of the steering shaft (80) is constructed as a laterally projecting arm (30) provided at its free end with a slider (31) guided on both side walls (32, 32′) of shaft (33).

8. Soil cultivation appliance according to claim 7, characterized in that the slider (31) has an axially symmetrical construction.

9. Soil cultivation appliance according to claim 7, characterized in that the slider (31) is fitted in rotary manner to the arm (30).

10. Soil cultivation appliance according to claim 5, characterized in that the steering shaft (8, 80) is fitted in articulated manner to the bearing body side directed towards the operator.

11. Soil cultivation appliance according to claim 10, characterized in that a universal joint is provided as the joint.

12. Soil cultivation appliance according to claim 2, characterized in that on the end facing the housing (2), the steering shaft (8) is provided with a bevel gear (16), which cooperates with a corresponding toothed disk (17) fixed to the housing (2).

13. Soil cultivation appliance according to claim 2, characterized in that the steering shaft is constructed as a flexible shaft.

14. Soil cultivation appliance according to claim 13, characterized in that the flexible shaft is guided in a support body pivotable about a vertical axis (11).

15. Soil cultivation appliance according to claim 1, characterized in that the housing (2, 20) is provided with front and rear wheels (3, 4; 30, 41) and that the vertical axis (11, 25) is located between the front and rear wheels.

16. Soil cultivation appliance according to claim 15, characterized in that the spacing of the vertical axis (11, 25) in the longitudinal direction of the housing (2, 20) is less than 30% of the spacing between the rear and front wheel axes.

17. Soil cultivation appliance according to claim 16, characterized in that the front wheel arrangement has one or two casters.

18. Soil cultivation appliance according to claim 16, characterized in that the wheel arrangements are not steerable and the contact surfaces (13) of the wheels (4a) have a limited sliding resistance with respect to lateral displacement.

19. Soil cultivation appliance according to claim 1, characterized in that the guide mechanism (8, 80) is removably fitted to the housing (2, 20).
